(19) United States
(12) Patent Application Publication
(10) Pub. No.: US 2011/0038358 A1
(43) Pub. Date: Feb. 17, 2011

(54) Apparatus And Method For Neighbor-Aware Concurrent Transmission Media Access Control Protocol

(76) Inventors: Li-Chun Wang, Hsinchu (TW); Chung-Wei Wang, Taipei (TW)

Correspondence Address: Lin & Associates;Intellectual Property, Inc., PO Box 2339, Saratoga, CA, 95070-0339, US

(21) Appl. No.: 12/689,238

(22) Filed: Jan. 19, 2010

(30) Foreign Application Priority Data
Aug. 14, 2009 (TW) 098127436

(51) Int. Cl. H04W 40/00

(52) U.S. Cl. 370/338

(57) ABSTRACT

An apparatus and method for neighbor-aware concurrent transmission media access control (MAC) protocol is provided, which determines whether a plurality of communication connections may be established concurrently in a wireless network, where each node in the network obtains the topology information of its multi-hop neighbors via a neighbor discover module. A cross-layer observation module integrates the physical and virtual carrier sensing, observes the address field of a control frame of a MAC layer in the wireless network, and compares the address field information of the control frame against the topology information obtained by the neighbor discover module to determine whether a plurality of connections may be established for concurrent transmission.

### TECHNICAL FIELD

The disclosure generally relates to an apparatus and method for neighbor-aware concurrent transmission (NACT) media access control (MAC) protocol.

### BACKGROUND

As the demands on wireless local area network (WLAN) rapidly increase, more and more access points (APs) are deployed. However, the mutual interference between neighboring APs will lead to the degradation of the network throughput. The cognitive radio (CR) technology is therefore developed to solve the throughput degradation problem in a multi-AP WLAN environment. To improve the throughput, cognitive WLAN is defined to have capability to identify concurrent transmission opportunity without interference between two links in a multi-AP environment. Based on the sensed environment information, the nodes on cognitive WLAN can self-adapt own transmission parameters to achieve concurrent transmission, as the examples of establishing concurrent transmission shown in FIG. 1 and FIG. 2.

In the example of FIG. 1, because AP 101 cannot serve the nodes 122 and 123 due to power constraint, two new APs 102 and 103 are added to relay the data traffic between AP 101 and nodes 122, 123 in order to cover the complete target area 140 of WLAN. If slave link 132 of AP 102 and node 122 and salve link 133 of AP 103 and node 123 can be on the same channel, and can concurrently transmit with master link 131 of AP 101 and node 121, the network throughput can be enhanced.

In the example of FIG. 2, due to the geographic obstacle, the signals from AP 201 cannot reach node 224. Hence, two APs 201, 202 are used to cover the complete target area 240 of WLAN, where the area includes four nodes 221-224. If link 232 of AP 202 and node 224 can concurrently transmit with link 231 of AP 201 and node 221 on the same channel, the network throughput can be enhanced.

The concurrent transmission scenarios may be divided into ingoing concurrent transmission scenario and outgoing concurrent transmission scenario, as shown in FIGS. 3A and 3B respectively. The examples in FIGS. 3A and 3B have four nodes A-D, with each node only able to communicate directly with neighbor nodes. In the ingoing concurrent transmission example of FIG. 3A, when master link A->B is established, slave link D->C can also be established concurrently. In the outgoing concurrent transmission example, when master link B->A is established, slave link C->D can also be established concurrently.

Of the carrier sense multiple access (CSMA)-based MAC protocol in WLAN, the carrier sensing schemes, including physical carrier sensing, virtual carrier sensing, and joint physical/virtual carrier sensing, will induce different types of hidden node and exposed node issues so that MAC protocol cannot support concurrent transmission easily. FIG. 4 shows a summary of the problem induced from the different types of CSMA-based MAC protocols, where ∘, x and - represent that corresponding protocol can overcome the problem, cannot solve the problem and does not consider the problem, respectively. For example, multiple access and collision avoidance (MACA)-typed MAC can only overcome the hidden node problem induced by physical carrier sensing scheme.

In the CSMA MAC protocol, each node senses the channel before transmitting data. After such physical carrier sensing, a node can transmit data if the channel is idle. FIGS. 5A and 5B show the hidden node issue that cannot be overcome by the physical carrier sensing scheme of CSAM. In FIG. 5A, assumed that A-F are nodes of a WLAN, where each node can only communicate directly with neighbor nodes. In FIG. 5B, assumed that link A->B is already established, and node C is out of the transmission range 510 of node A. Because node C senses an idle channel, node C may transmit data to node B, and this transmission may possibly collide with the data transmission from node A to node B. This is an induced hidden node problem.

FIG. 6 shows the exposed node issue that cannot be overcome by the physical carrier sensing scheme of CSMA. In FIG. 6, assumed that link B->A of FIG. 5A is already established, and B is during the process of transmitting data to node A. However, node C is refrained from transmitting data because node C is exposed in transmission range 610 of node B and senses that node B is transmitting. As node D is out of transmission range 610 of node B, and node A is out of the transmission range of node C, the concurrent transmission opportunity for link B->A and link C->D is wasted. This is an induced exposed node problem. Therefore, the prohibition of node C's transmission is unnecessary because of the channel sensing. Specifically, node C is exposed in node B's transmission range but node C's receiver (node D) is outside of node B's interference region.

Because physical carrier sensing may be unreliable in WLAN, MACA protocol introduced the concept of virtual carrier sensing. The virtual carrier sensing technology is that a node first broadcasts a Request-To-Send (RTS) frame before transmitting data. The target receiver, after receiving the RTS frame, replies a Clear-To-Send (CTS) frame. The transmitter, after receiving the CTS frame, starts to transmit the DATA frame, and the corresponding receiver replies with an acknowledgement (ACK) frame.

A key ingredient for the virtual carrier sensing technology is the Network Allocation Vector (NAV) embedded in the CTS frame. Except for the target user that sent RTS previously, all the other nodes receiving the CTS frame will defer transmission until the period defined in NAV is expired. In this manner, these nodes stay quiet as if they sensed a busy channel. By adopting NAV to indicate the reserved channel usage time in the RTS and CTS frames, MACA protocol still cannot completely resolve the exposed node issue resulted from physical carrier sensing because the RTS/CTS handshaking mechanism does not take the collision between CTS frame and DATA frames into account.

FIG. 7 shows the hidden node issue that cannot be overcome by the virtual carrier sensing scheme of CSMA. In FIG. 7, assumed that link B->A is already established, and the RTS/CTS handshaking process is successfully performed. Node B is transmitting data to node A when node C tries to connect to node D. Based on the MACA protocol, a node is allowed to transmit an RTS frame as long as the node does not hear a CTS frame from other nodes. In this case, when node D replies node C with a CTS frame, collision will occur because the transmission of node B's DATA frame can also reach node C. This collision occurs because node D is hidden to node B, and collision scenario is similar to the hidden node issue induced by physical carrier sensing except that collision 710 occurs between a CTS frame and a DATA frame, instead of collision between pure DATA frames. Therefore, the hidden node issue induced by the virtual carrier sensing prohibits link B->A and link C->D from concurrent transmission.

FIG. 8 shows the exposed node issue that cannot be overcome by virtual carrier sensing of MACA protocol. In FIG. 8, assumed that link A->B is already established. Therefore, a node is not allowed to transmit any frame to prevent the hidden node issue as long as hearing a CTS frame. Because node C is exposed to the CTS frame of node B, node C cannot reply a CTS frame to node D, marked as 810. Hence, the concurrent transmission opportunities of links A->B and D->C are wasted. In other words, exposed node problem induced by virtual carrier sensing prevents the concurrent transmission of links A->b and D->C.

The joint physical/virtual carrier-sensing scheme, such as, distributed coordination protocol (DCF) of IEEE 802.11 MAC protocol, was proposed to alleviate the physical carrier-sensing and virtual carrier-sensing hidden node problems. In IEEE 802.11 MAC protocol, the IEEE 802.11 WLAN adopts both physical and virtual carrier sensing simultaneously. If a node receives the RTS or CTS frame that is not for the designated user, the node will be forbidden to access the channel. Based on these principles, the IEEE802.11 MAC protocol can solve the physical carrier-sensing hidden node problem. However, the virtual carrier-sensing hidden node issue (or equivalently the physical carrier-sensing exposed node issue) cannot be completely solved by the 802.11 MAC protocol. Specifically, the second principle will limit node C to transmit another RTS frame in FIG. 6. Therefore, the collision of the CTS frame of node D and the DATA frame of node B will not happen.

The RTS/CTS mechanism of the IEEE 802.11 MAC protocol also leads to a new false blocking node problem. Basically, the false blocking node problem means that a node is blocked by a non-existent transmission. The main reason resulting in the false blocking node problem is the fact that each node will defer its transmission if the node receives any RTS frame according to the IEEE802.11 MAC protocol. In the embodiment of FIG. 5, assume that link E->F is already established and in the meanwhile node C sends an RTS frame to node D. Because node D is already blocked by the RTS and CTS frames sent from nodes E and F, node D cannot reply a CTS frame back to node C. Hence, as node C not receiving any response from node D, node C may draw the conclusion that a frame collision occurs for the previously transmitted RTS frame, and the RTS frame must be retransmitted. Consequently, node B will be blocked by the non-existing link C->D. In this scenario, node B is said to be a false blocking node. The false blocking node problem can be propagated further to other nodes. For example, when node A sends an RTS frame to node B and node B is already blocked by the non-existing link C->D, node B cannot reply a CTS frame to node A. Hence, the concurrent transmission opportunities of links E->F and A->B cannot be exploited because of the false blocking node problem. As node C, the RTS frame sent from node A will block the neighboring node, and result in further false blocking nodes. This problem is called as blocking node propagation issue.

To address the concurrent transmission issue, an enhanced version of the MACA protocol, called MACA with Enhanced Parallelism (MACA-P) is proposed by S. Bansal et. al. The key idea of MACA-P protocol is to introduce an extra gap between the RTS/CTS frames and the subsequent DATA frames in addition to the short inter-frame space (SIFS) of IEEE 802.11 protocol. This extra gap allows all the neighboring nodes to exchange the RTS/CTS frames for the purpose of concurrent transmission to establish slave links for concurrent transmission. However, the MACA-P technique does not completely solve the virtual-carrier exposed node issue. For example, the receiver of slave link cannot respond with the CTS frame when the transmitter of slave link transmits the RTS frame near the end of the extra gap. In other words, this slave link cannot be established successfully. Also, D. Shukla et. al. and D. Kim et. al. proposed a parallel-MAC (P-MAC) to apply the RTS/CTS/DATA/ACK four-way handshaking procedure for long packets and DATA/ACK two-way handshaking procedure for short packets. This technique takes the outgoing transmission issue into account, but does not consider the ingoing transmission issue.

H. W. A. Velayutham et. al. exploits the fragmentation mechanism to partition the long packets into a plurality of segments to increase the concurrent transmission opportunity. When the master transmission link is transmitting DATA/ACK frames, the slave transmission link can transmit a RTS frame at the same time to achieve concurrent transmission. However, because the size of the last segment is variable, the transmitting end of the slave transmission link must monitor the NAV of the last segment from the master transmission link to guarantee that the slave transmission link will not interfere with the master transmission link. Hence, the transmitting end of the slave transmission link must include two sets of wireless modules to provide the capability of concurrent transmission and receiving. In addition, the receiving end of the slave transmission link can respond only after the master transmission link finishes transmitting data. In this manner, the transmitting end of the salve transmission link may mistake as the expiration of retransmission period, and starts to retransmit.

N. Santhapuri et. al. uses RTS/CTS/DATA frames to achieve data exchange. Each node includes an additional response field in the header of each frame to notifying other nodes that what frames have been successfully received by this node. Because no ACK frame is used for data exchange, the interference between the ACK frame of the master transmission link and the DATA frame of the slave transmission link is avoided. Therefore, concurrent transmission is achieved. The receiving end of this technique needs the indirect response to notify whether the packets are successfully received, thus, arbitrary data flow models are not taken into account.

Li-Chun Wang et. al. proposed a Concurrent Transmission MAC protocol (CT MAC). CT MAC can identify and intelligently exploit the concurrent transmission opportunity in a collision-free network environment. This protocol uses a two-step concurrent transmission neighbor exploitation procedure to identify the network topology environment and uses an integrated observation mechanism to identify whether a plurality of communication connections can be established for concurrent transmission without interference. However, in an actual network environment, collision of information transmission often exists, thus, leads to the mistakes by CT MAC in exploiting the concurrent transmission opportunity.

### SUMMARY

The disclosed exemplary embodiments of the present invention may provide an apparatus and method for neighbor-aware concurrent transmission media access control protocol, for identifying whether a plurality of communication connections can be established simultaneously in a wireless network.

In an exemplary embodiment, the disclosed relates to an apparatus for neighbor-aware concurrent transmission media access control protocol. The apparatus comprises a neighbor discover module that executes a neighbor discover procedure so that each node in the wireless network obtains the topology information of its multi-hop neighbors; and a cross-layer observation module that integrates the physical and virtual carrier sensing, observes the address field of a control frame of a media access control layer in the wireless network, and compares the address field information of the control frame against the topology information obtained by the neighbor discover module to determine whether a plurality of communication connections is established for concurrent transmission.

In another exemplary embodiment, the disclosed relates to a method for neighbor-aware concurrent transmission media access control protocol. The method comprises: executing a neighbor discover procedure through a neighbor discover module, so that each node in the wireless network obtains the topology information of its multi-hop neighbors; and through a cross-layer observation module, integrating the physical and virtual carrier sensing, observing the address field of a control frame of a media access control layer in the wireless network, and comparing the address field information of the control frame against the topology information obtained by the neighbor discover module to determine whether a plurality of communication connections is established for concurrent transmission.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 shows an exemplary schematic view of using a plurality of access points for concurrent transmission.

FIG. 2 shows another exemplary schematic view of using a plurality of access points for concurrent transmission.

FIGS. 3A-3B show schematic view of scenarios of ingoing concurrent transmission and outgoing concurrent transmission, respectively.

FIG. 4 shows the comparison of different CSMA-based MAC protocols over the issue of induced hidden or exposed node problems.

FIGS. 5A-5B show that the physical carrier sensing of CSMA cannot overcome the induced hidden node problem.

FIG. 6 shows that physical carrier sensing of CSMA cannot overcome the induced exposed node problem.

FIG. 7 shows that MACA protocol cannot overcome the hidden node problems induced by virtual carrier sensing.

FIG. 8 shows that MACA protocol cannot overcome the exposed node problems induced by virtual carrier sensing.

FIG. 9 shows an exemplary schematic view of an NACT MAC apparatus, consistent with certain disclosed embodiments.

FIG. 10 shows an exemplary flowchart of the neighbor discover procedure, consistent with certain disclosed embodiments.

FIG. 11 shows an exemplary schematic view of a network topology, consistent with certain disclosed embodiments.

FIG. 12 shows how a node discovers neighbors using the network topology of FIG. 11 as an example, consistent with certain disclosed embodiments.

FIG. 13 shows how NACT MAC protocol solves the exposed node problem induced by virtual carrier sensing of FIG. 8, consistent with certain disclosed embodiments.

FIG. 14 shows definitions of notations, consistent with certain disclosed embodiments.

FIG. 15 shows how NACT MAC solves the hidden node problem induced by virtual carrier sensing of FIG. 7, consistent with certain disclosed embodiments.

FIG. 16 shows an exemplary flowchart of ingoing concurrent transmission of NACY MAC protocol, consistent with certain disclosed embodiments.

FIG. 17 shows an exemplary flowchart of outgoing concurrent transmission of NACY MAC protocol, consistent with certain disclosed embodiments.

FIG. 18 shows an observation flow of the NACT MAC protocol on the transmitting end or receiving end of a master link, consistent with certain disclosed embodiments.

FIGS. 19A-19D show exemplary results of the decision whether concurrent transmission can be established for different cross-layer observation results using the network topology of FIG. 11 as an example, consistent with certain disclosed embodiments.

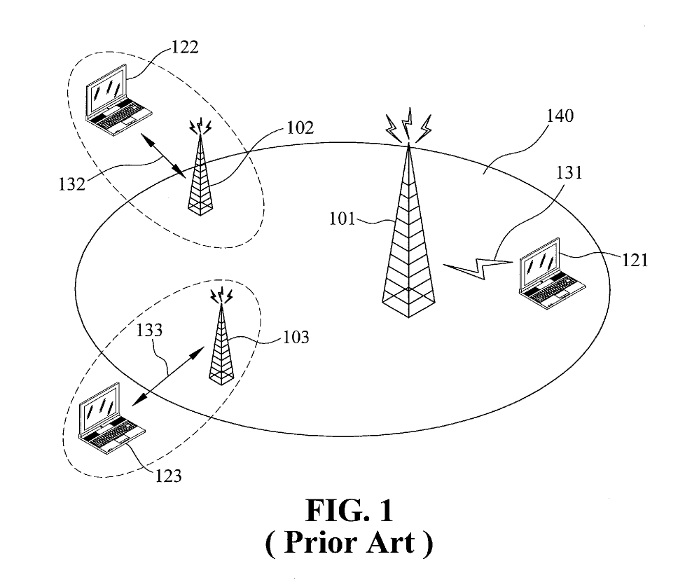

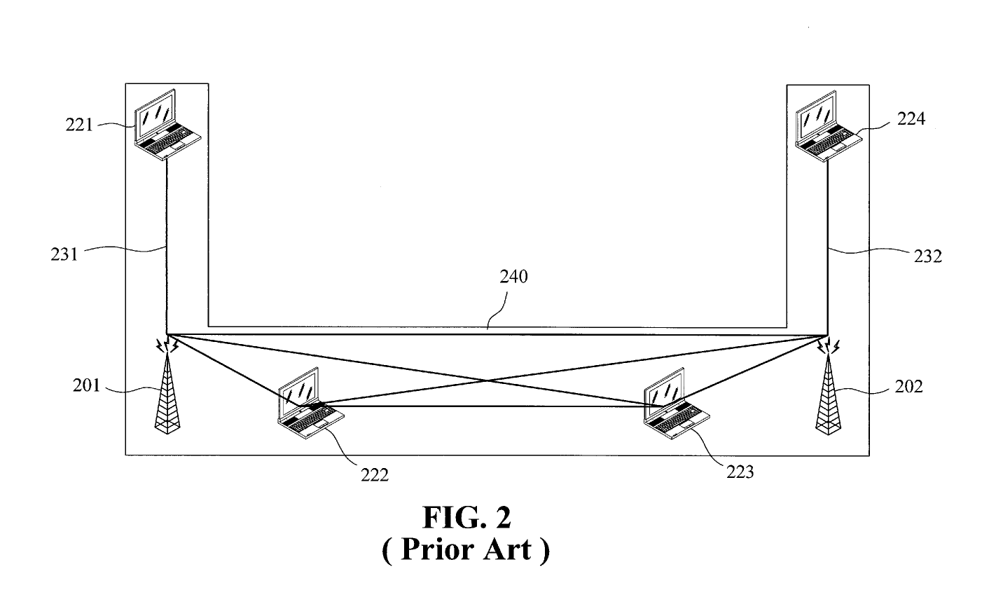

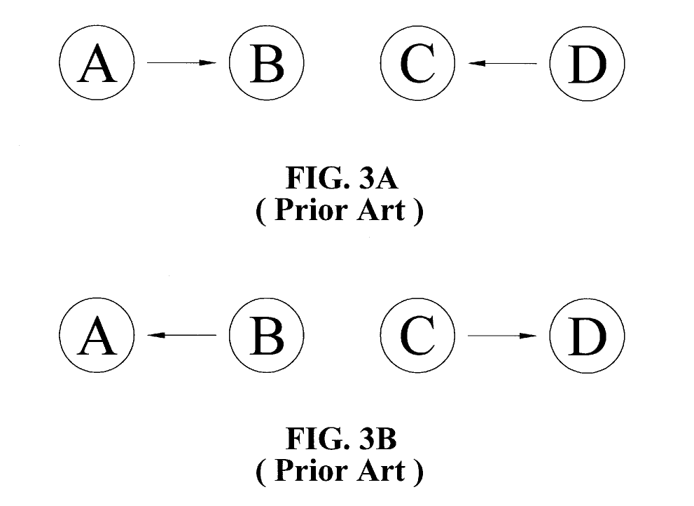

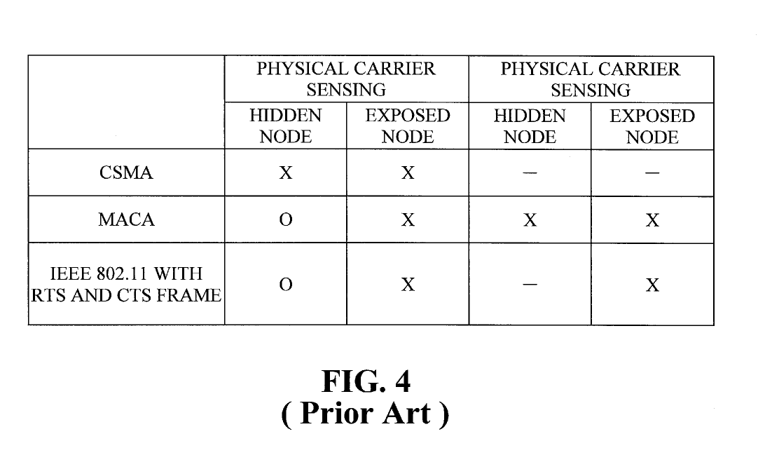

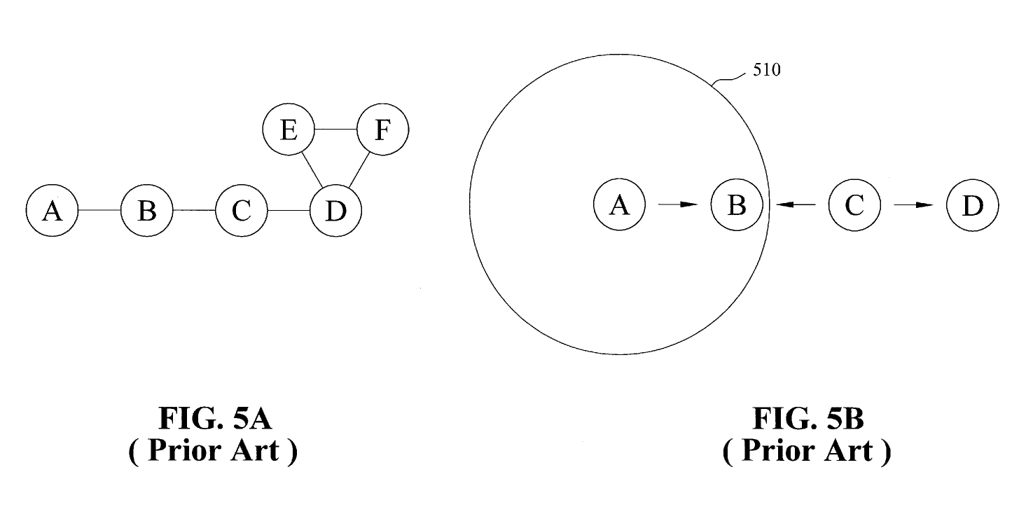

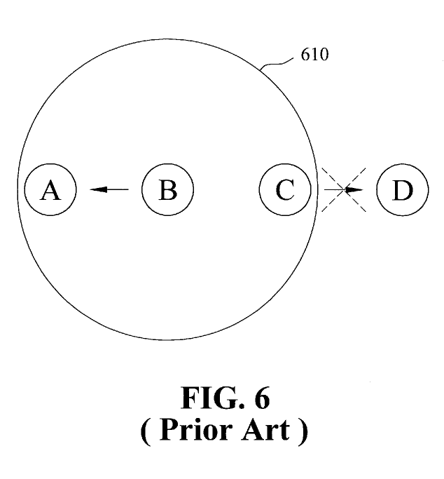

### DETAILED DESCRIPTION OF THE EMBODIMENTS

The exemplary embodiments of the present invention provide a technique of neighbor-aware concurrent transmission (NACT) media access control (MAC) protocol to solve the hidden and exposed node problems with physical and virtual carrier sensing to achieve high spectrum throughput. The NACT MAC technique, in addition to identifying the concurrent transmission opportunity, may also solve the false blocking node propagation problem. Furthermore, the NACT MAC technique is also applicable to the general traffic and channel models.

NACT MAC technique is based on a neighbor discover procedure so that each node in a wireless network may obtain the topology information of all of its n-hop neighbors, where n is an integer greater than or equal to 2. The exemplary embodiments also disclose a cross-layer observation mechanism. The observation mechanism determines whether the concurrent transmission opportunity exists among a plurality of connections through physical and virtual carrier sensing and observing the address field of a control frame. The connection establishment for concurrent transmission requires no control channel, instead, is realized by a distributive concurrent transmission MAC mechanism.

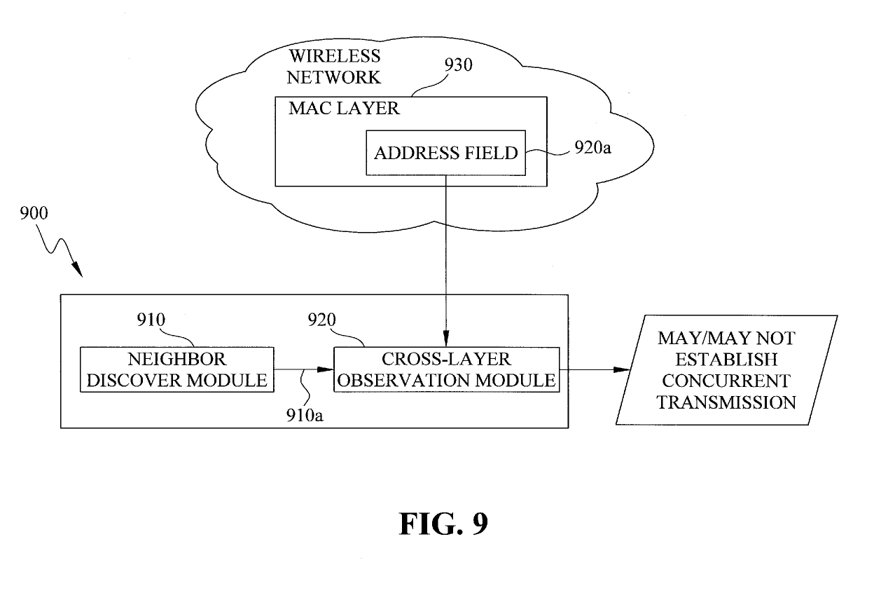

FIG. 9 shows an exemplary schematic view of an NACT MAC apparatus, consistent with certain disclosed embodiments. Referring to FIG. 9, NACT MAC apparatus 900 is to identify whether a plurality of communication connections may be established concurrently in a wireless network. NACT MAC apparatus 900 comprises a neighbor discover module 910 so that each node in this wireless network obtains topology information 910b of its multi-hop neighbors; and a cross-layer observation module 920 that integrates physical and virtual carrier sensing, observes address field 920a of a control frame in a MAC layer 930 of the wireless network, and compares the address field of the control frame against topology information 910b obtained by neighbor discover module 910 to determine whether a plurality of communication connections may be established for concurrent transmission.

Neighbor discover module 910, through executing a neighbor discover procedure, allows each node in this wireless network to obtain the topology information of its n-hop neighbors and establish its neighbor-aware list.

Cross-layer observation module 920 may identify which node the transmitting end or receiving end of a master transmission link is in the wireless network and whether the node supports concurrent transmission according to the information in address field 920a of the control frames. There are two types of concurrent transmissions established by each node in the wireless network, namely, ingoing concurrent transmission and outgoing concurrent transmission.

Through each result of the comparison by cross-layer observation module 920, each node in the wireless network may establish a corresponding table list and determines whether the plurality of communication connections supports concurrent transmission under each result.

NACT MAC apparatus 900 may be realized in various ways. The structure, for example, may be a transceiver of a wireless network or a wireless network card, and so on.

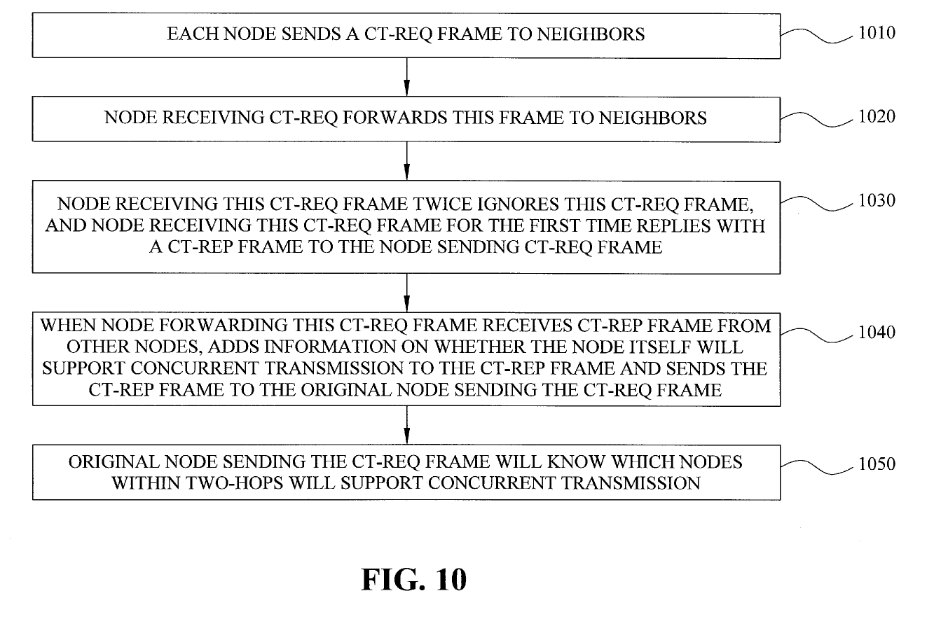

FIG. 10 shows an exemplary flowchart of an embodiment of the neighbor discover procedure, consistent with certain disclosed embodiment. Referring to FIG. 10, in step 1010, each node sends a concurrent transmission request (CT-REQ) frame to the neighbors. in step 1020, the nodes receiving the CT-REQ frame transfer this frame to its neighbors. In step 1030, the nodes receiving the CT-REQ frame twice ignore the CT-REQ frame, and the nodes receiving the CT-REQ frame once respond a concurrent transmission reply (CT-REP) frame to the transmitting node of the CT-REQ frame, where the CT-REP frame contains information on whether concurrent transmission may be supported by the nodes receiving the CT-REQ frame once. In step 1040, when the nodes transferring the CT-REQ frame receive a CT-REP frame from other nodes, these nodes will add the information on whether to support concurrent transmission in the CT-REP frame and transfers this CT-REP frame to the original node transmitting the CT-REQ frame. In step 1050, the original node transmitting the CT-REQ frame knows which nodes within n-hops support concurrent transmission (in this example, n=2).

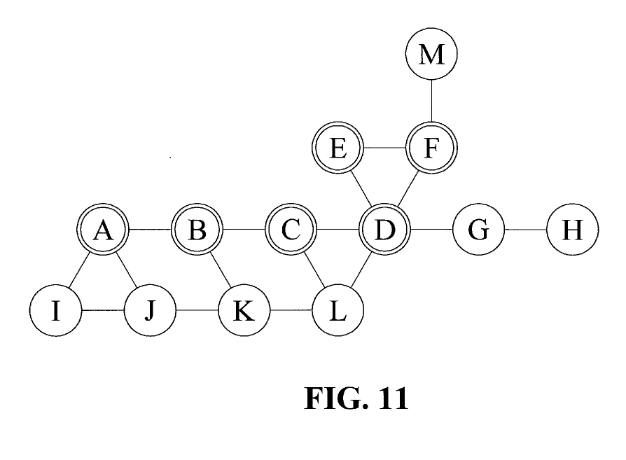

The following takes the network topology of FIG. 11 as an example to illustrate the neighbor discover procedure. In the exemplar of FIG. 11, nodes A, B, C, D, E, and F are all cognitive nodes with NACT MAC capability, while nodes G, H, I, J, K, L and M are legacy nodes with DCF capability.

The neighbor discover procedure may be explained as follows. In the beginning, each cognitive node broadcasts a CT-REQ frame to neighbors within n-hops. As soon as a cognitive node receives the CT-REQ frame, the cognitive node must reply with a CT-REP frame. This handshaking mechanism is similar to the route setup procedure of dynamical source routing protocol. From the received CT-REP frame, the node that transmitted this CT-REQ frame may know which cognitive neighbors support concurrent transmission. Other than node C, all the other nodes must also execute this procedure to find the cognitive neighbors.

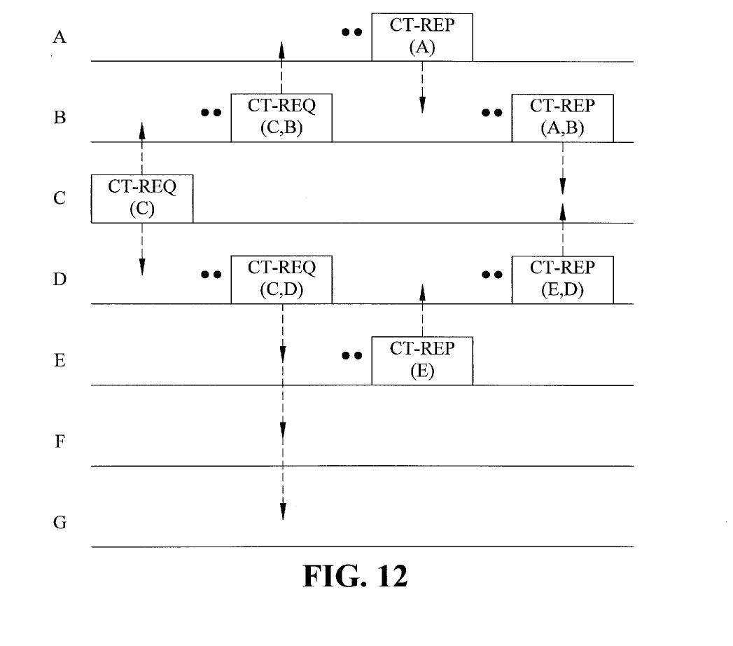

FIG. 12 takes the network topology of FIG. 11 as an example to illustrate how node C finds cognitive neighbors. First, node C broadcasts the CT-REQ frame to nodes B and D. Because nodes B and D are cognitive nodes, nodes B and D mark a sign on the CT-REQ frames and then immediately forward the CT-REQ frames to their respective neighbors. That is, node B forwards CT-REQ(C,B) to node A, and node D forwards CT-REQ(C,D) to E, F and G, respectively.

Assume that node F does not allow to support concurrent transmission and node G is a legacy node that does not understand the CT-REQ frame. Therefore, nodes F and G will not reply the CT-REP frame for this CT-REQ. In the meanwhile, node E replies a CT-REP(E) frame to node D and node A replies a CT-REP(A) frame to node B, respectively, where CT-REP(E) and CT-REP(A) frames represent that nodes E and A are willing to support the establishment of concurrent transmission links. Next, nodes B and D reply a CT-REP(A,B) frame and a CT-REP(E,D) frame to node C, respectively. Hence, node C finds that nodes A, B, D and E are cognitive neighbors within two hops and then records nodes A, B, D and E in the cognitive-neighbors list of node C.

After the cognitive-neighbors list is established, the cross-layer observation mechanism is used to integrate physical and virtual carrier sensing and observe the address field of the control frames so that each node may identify whether concurrent transmission can be established. This technique includes monitoring the channel state, overhearing the RTS and CTS frame, and obtaining the receiver address (RA)/transmitter address (TA) in the overheard RTS/CTS frame. The specification of RTS/CTS frame may refer to the definition of IEEE 802.11 MAC protocol specification.

Monitoring the channel state is the physical carrier sensing, indicating that each node is actually monitoring the channel state. For example, in CSMA protocol, a node may transmit data when the channel is idle. Overhearing the RTS/CTS frame is the virtual carrier sensing, indicating that each node may use the overheard RTS/CTS frame to identify whether neighboring nodes are currently transmitting or receiving. The details are defined in the IEEE 802.11 protocol. For example, as defined in the DCF mechanism of conventional IEEE 802.11 MAC protocol, a node is forbidden to transmit when the node is overhearing the RTS/CTS frame. However, as aforementioned, it is possible that a link that can actually exist may be blocked by a non-existent link.

To avoid misjudgment, in the disclosed, even a node has ever used a virtual carrier sensing to overhear the RTS frame, the physical carrier sensing is used again to confirm. When physical carrier sensing finds that the channel is idle, each node further observes the address field of the RTS/CTS frame of the control frame to determine whether itself may directly communicate with the receiving end of the master transmission link, or with the transmitting end of the master transmission link. Hence, through obtaining the RA and TA of RTS and CTS frames, it is able to identify whether the transmitting end or the receiving end of the master transmission link of a node supports concurrent transmission.

In combination with physical and virtual carrier sensing mechanism, as well as the RA and TA fields of RTS and CTS frames, the node may compare the address field and the result obtained from the neighbor discover procedure to determine whether the existing links support concurrent transmission. In addition, from these observed information, each node may identify its transmission direction in concurrent transmission, i.e., transmitting or receiving.

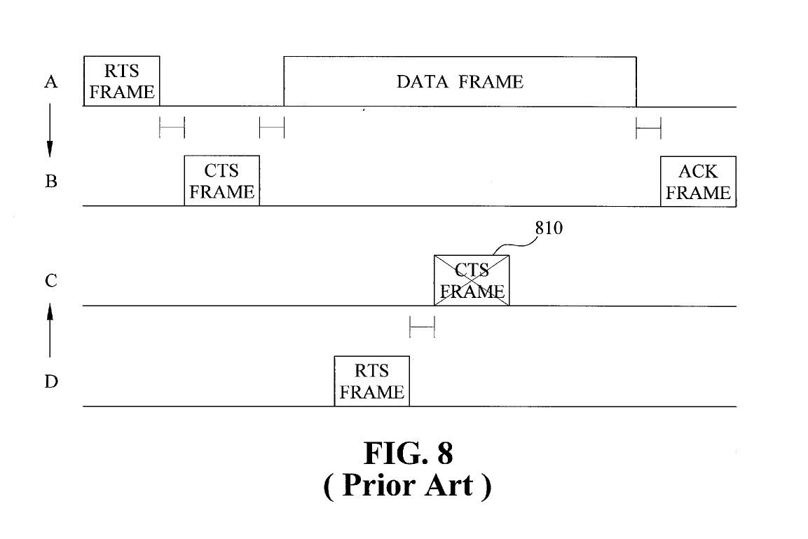

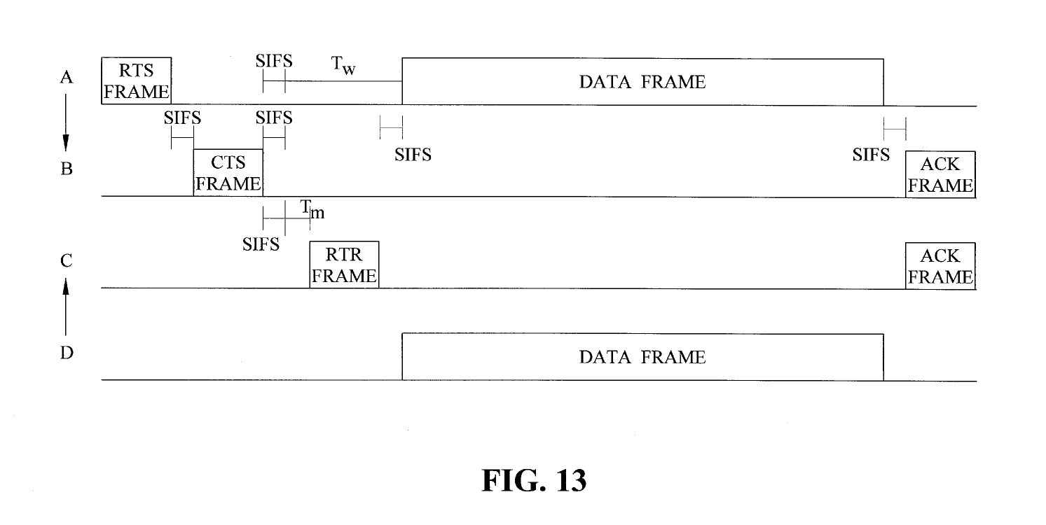

After identifying the concurrent transmission opportunity, the disclosed NACT MAC protocol provides a distributive concurrent transmission mechanism in the MAC layer. This mechanism does not need to use the control channel to establish a slave transmission link when the master transmission link exists. FIG. 13 shows how NACT MAC protocol solves the exposed node problem from the virtual carrier sensing of FIG. 8, consistent with certain disclosed embodiment. The NACT MAC protocol may help the exposed node to function successfully as receiving end for slave transmission link.

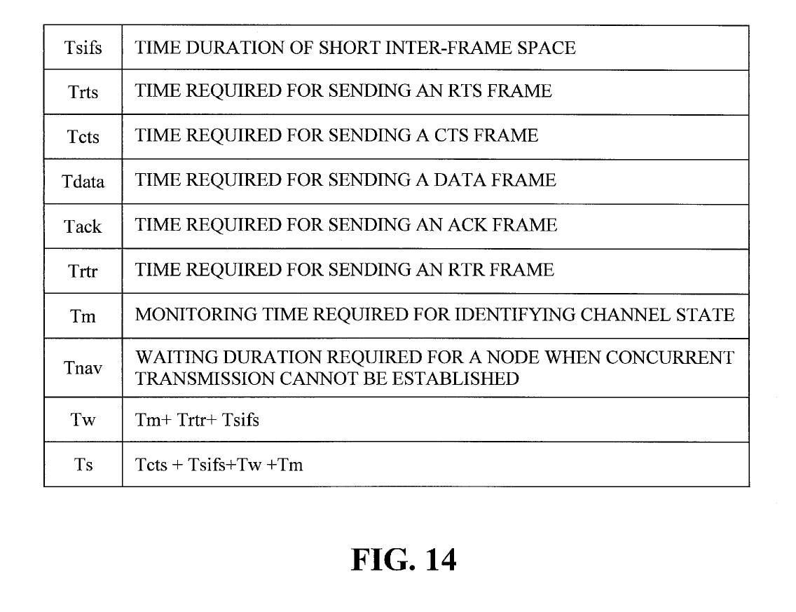

As shown in FIG. 13, during the setup process of the master transmission link A->B, node A sends an RTS frame, and then node B responds with a CTS frame. Since node C looks up the RA field of the overheard CTS frame, node C knows which node the transmitting end of the master link is. By checking the cognitive-neighbors list, node C can decide whether both the transmitting end and the receiving end of the master link A->B are cognitive nodes. Moreover, because node A is aware of having a cognitive neighbor within two hops, node A will not immediately transmit the DATA frame to node B after the time duration of short inter-frame space (SIFS) Tsifs, but will wait for an additional duration Tw. Hence, referring to the notation definitions in FIG. 14, the NAV (i.e., Tnav) of RTS frame of node A will be equal to 3Tsifs+Tcts+Tw+Tdata+Tack, where additional waiting duration Tw is equal to the sum of Tsifs, monitoring time Tm, and transmission time Trtr of Ready-To-Receive (RTR) frame. Monitoring time Tm is the duration for identifying the channel state in order to identify whether the node itself can be a receiving end.

Because node C only overhears the CTS frame from node B but no RTS frame in an idle channel after duration Tm, node C knows that itself is an exposed node. Furthermore, because node B does not receive any RTS or CTS frame from node D, node D is likely to be idle and available for data transmission. Hence, node C may send an RTR frame to node D during Trtr in order to request data from node D. This RTR frame should record the allowed data length in order to synchronize the ACK frame between the master and the slave links.

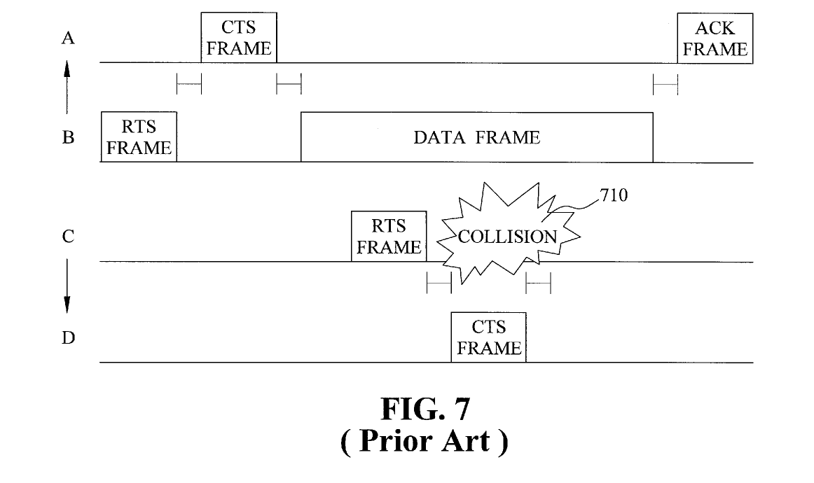

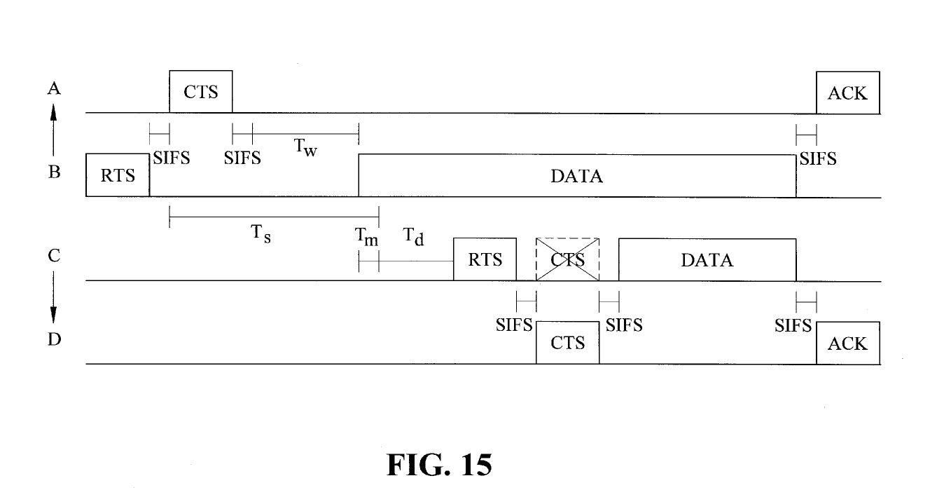

FIG. 15 shows how NACT MAC protocol solves the hidden node problem from the virtual carrier sensing of FIG. 7, consistent with certain disclosed embodiments. The NACT MAC protocol improves the existent RTS/CTS/DATA/ACK handshaking procedure to solve the collision problem between the CTS frame from node D and DATA frame from node B. As shown in FIG. 13, if node C does not receive any RTS or CTS frame from node D, node D is likely to be idle and available for receiving data. The implication is that the CTS frame from node D is not required in establishing the slave link. After node C sends the RTS frame, node C waits for 2Tsifs+Tcts, and then sends a DATA frame to node D.

The following describes the determination of the transmission duration of the slave link. In FIG. 15, assume that nodes A and B are both cognitive nodes. When nodes A and B know that the neighboring nodes are also cognitive nodes, nodes A and B will delay the DATA frame transmission. In this situation, the data transmission duration TC->D of slave link C->D is the maximum of 0 and Tnav−Tw−Tm−Td−Trts−2Tcts−Tack−5Tsifs, where Td is the delay duration for waiting for the traffic from node C to node D. If the transmission time for sending a packet in the slave link is longer or shorter than TC->D, the original packet can be fragmented or padded with dummy bits.

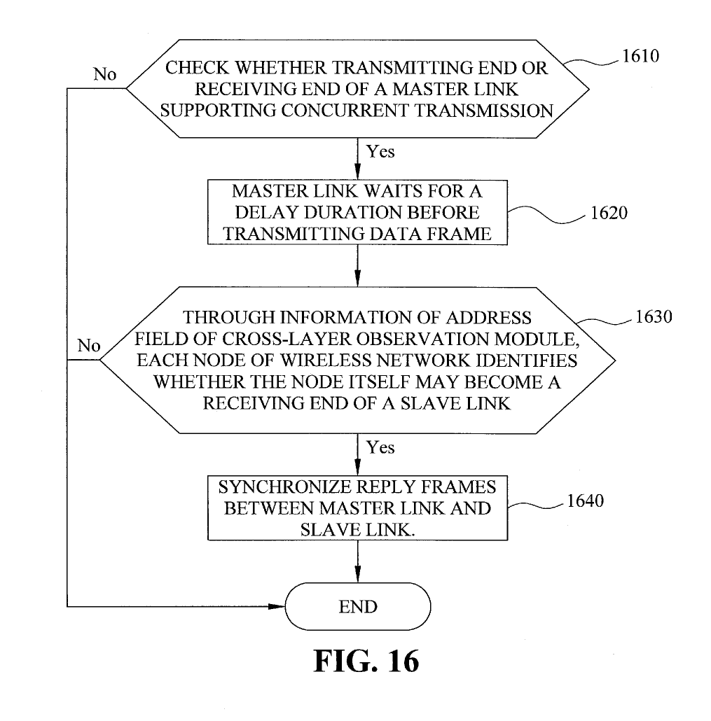

Following the exemplary embodiment in FIG. 13, FIG. 16 shows an exemplary flowchart of establishing the ingoing concurrent transmission according to a mutually interference-free transmission protocol. Referring to FIG. 16, in step 1610, it is to check the transmitting end or receiving end of a master link supports concurrent transmission. If so, the master link transmits the DATA frame after waiting for a delay duration, as shown in step 1620. In step 1630, each node in the wireless network identifies, through the information of address field in observed by the cross-layer observation module, whether itself may become a receiving end of a slave link. In step 1640, it is to synchronize the reply frame between the master link and the slave link.

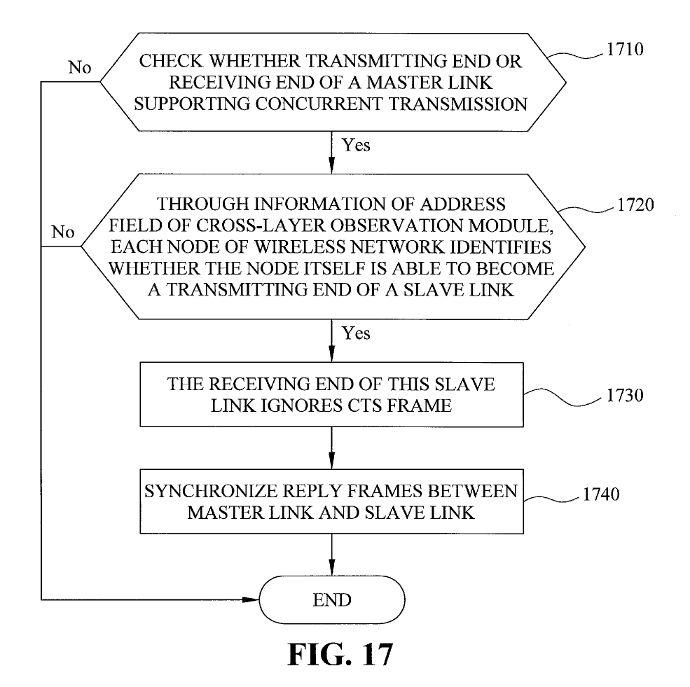

Following the exemplary embodiment in FIG. 15, FIG. 17 shows an exemplary flowchart of establishing the outgoing concurrent transmission according to a mutually interfere-free transmission protocol. Referring to FIG. 17, in step 1710, it is to check the transmitting end or receiving end of a master link supports concurrent transmission. If so, through the information of address field in observed by the cross-layer observation module, each node in the wireless network identifies whether itself may become a transmitting end of a slave link, as shown in step 1720. If the node may become the transmitting end, the receiving end of the slave link ignores the CTS frame, as shown in step 1730. In step 1740, it is to synchronize the reply frame between the master link and the slave link.

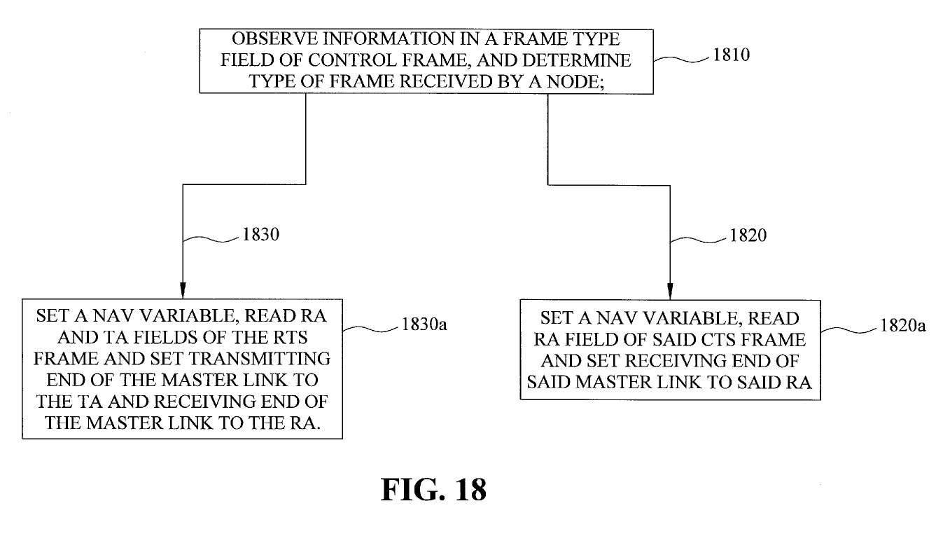

FIG. 18 further describes an observation flowchart on the transmitting or receiving end of a master link by NACT MAC protocol, consistent with certain disclosed embodiments. Referring to FIG. 18, in step 1810, it is to observe the information in the frame type field of the control frame, and determine the type of the frame received by the node. When the frame type is a CTS frame (step 1820), step 1820a is taken. When the frame type is an RTS frame (step 1830), step 1830a is taken. When the frame type is a DATA frame or a REPLY frame, the process terminates.

In step 1820a, it is to set a NAV variable to indicate the required waiting for the node when concurrent transmission cannot be established, and to read RA field of CTS frame and set the receiving end of the master link to RA. In step 1830a, it is to set a NAV variable to indicate the required waiting for the node when concurrent transmission cannot be established, and to read RA and TA fields of RTS frame and set the transmitting end of the master link to TA and receiving end of the master link to RA.

The following describes how the concurrent transmission of the NACT MAC protocol guarantees the successful establishment of the master link (if the master link is not established, it is not necessary to activate the concurrent transmission process.) According to the NACT MAC protocol, even a channel is classified as busy because of the previous use as a virtual channel, the protocol suggests using the physical carrier sensing for re-confirmation. In FIG. 15, if both nodes A and B are cognitive nodes, node C may activate a timer to wait for a period of time, i.e., Ts−Tm−Tsifs after receiving RTS frame from node B, and then node C spends time Tm to execute the physical carrier sensing.

As shown in FIG. 15, if the channel is busy, node C knows the data transmission to node D must be conducted in concurrent transmission mode, i.e., node C must ignore the CTS frame. If the channel is idle, node C must receive a CTS frame after transmitting an RTS frame because node C knows that the data transmission to node D is not conducted in the concurrent transmission mode. In the concurrent transmission mode, the NAV of the RTS frame of node C may be set to the remaining NAV value of the master link, i.e., Tnav−Tsifs−Ts−Trts. In the non-concurrent transmission mode, because node A does not reply CTS frame, or node B does not successfully receive CTS frame, the establishment of master link fails. In this situation, there is no additional criterion for setting the NAV value of RTS frame of node C.

Hence, the process of NACT MAC protocol using cognitive capability may be summarized as the following stages. In the sensing stage, the physical and virtual carrier sensing are used to identify channel state. Then, in the analysis stage, each node checks the RA/TA field of the CTS or RTS frame to determine which concurrent transmission mode is supported. In the decision stage, if concurrent transmission may be established, the cognitive node of the salve link must decide how much time the node may use the slave link. Finally, in the action stage, by synchronizing the master link and the slave link, the concurrent transmission is established. The establishment of the concurrent transmission of the plurality of communication links in the wireless network follows a mutually interfere-free transmission protocol. After executing the action stage, the corresponding result will affect the wireless environment of the network topology.

FIG. 15 described that the establishment of salve link C->D does not need the CTS frame from node D. However, two cases will render the failure of the establishment of the slave link. Take network topology of FIG. 11 as example. In the first case, assume that master link B->A is established, and slave link C->D is under establishing. First, consider the case where link G->H is already established. Because node D overhears an RTS frame from node G, node D cannot responds with a CTS frame to node C. In NACT MAC protocol, node C ignores the CTS frame from the expected receiving end D and directly transmits DATA frame to node D, and then the DATA frame will collide at node D with DATA frame from node G. Thus, the establishment of slave link C->D fails. In other words, the slave link from node C to node D cannot be established.

The other case is described as follows. Assume that link H->G is already established. Although node D is blocked by the CTS frame from node G, node C can still directly transmit DATA frame to node D because node C ignores the response from node D. However, because node E does not know node D is currently in receiving mode, node D transmits data to node F. In this manner, link E->F interferes with link C->D. Hence, the establishment of slave link C->D fails. Even though the mistakes lead to the failure of establishing slave link C->D, the master link is not affected. Therefore, NACT MAC protocol can still operate, but each transmission data has to wait for an additional duration Tw.

NACT MAC protocol also avoids the aforementioned propagation problem of false blocking node. Take network topology of FIG. 11 as an example. Assume that master link E->F is already established, and the aforementioned propagation problem of false blocking node will reduce the concurrent transmission opportunity of link E [symbol] F and link A [symbol] B. NACT MAC protocol adopts a double channel check (DCC) method to prevent the false blocking node from occurring, described as follows. Because node B only hears an RTS frame node C, node B will execute physical carrier sensing after a predefined delay duration. If this channel is idle, node B concludes that a false blocking node problem has occurred and node B has the right to establish new link. Hence, node B can execute bi-directional data transmission with node A. In other words, the false blocking node problem will not propagate.

NACT MAC protocol may further handle some special cases. Take the network topology of FIG. 11 as an example. Assume that master link E->F is already established. Node D can overhear the RTS frame transmitted by node E to node F and node C and node F can transmit CTS to node D and node E, respectively. In this case, a collision will occur at node D so that node D will not be able to receive any frame successfully. From the point of view of node D, node D only receives RTS frame but not CTS frame, senses a busy channel, and this busy channel is originated from link E->F after a predefined transmission duration. Hence, node D mistakenly thinks that node D can be a transmitting end of the slave link. However, the transmission from node D will interfere the receiving of node D. In other words, links E->F and D->C are actually forbidden to execute concurrent transmission.

The way NACT MAC protocol handle this case is as follows. If the RA field of the overheard RTS frame points out that the receiving end of the master link is a one-hop neighbor of a node, this node is forbidden to be the transmitting end of the slave link. Hence, by observing the RA field of the RTS frame of node E, node D knows that the receiving end (i.e., node F) of the master link is a one-hop neighbor and node D will not transmit data in order to avoid interfering the existing link. Similarly, NACT MAC protocol can also observe the TA field of RTS frame and RA field of CTS frame to identify whether the neighboring node is a potential transmitting or receiving end.

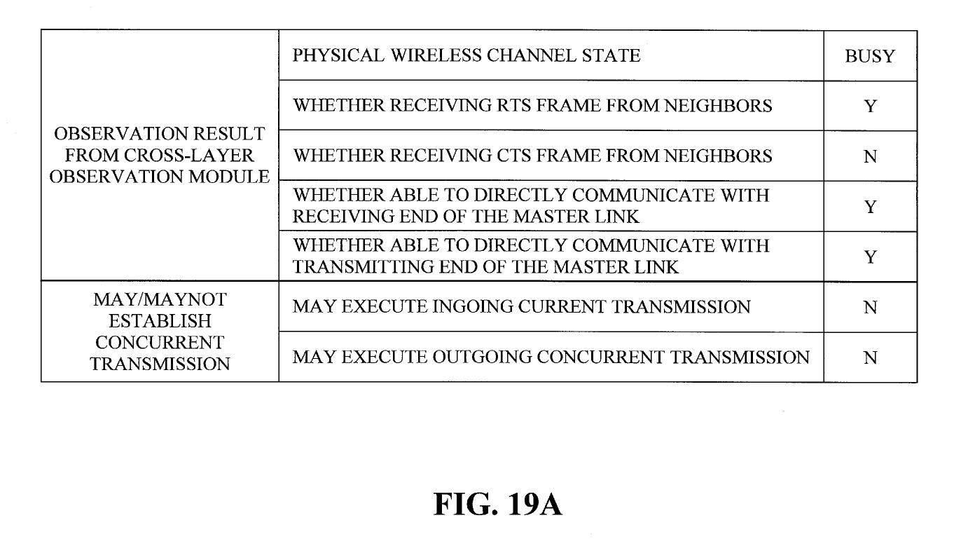

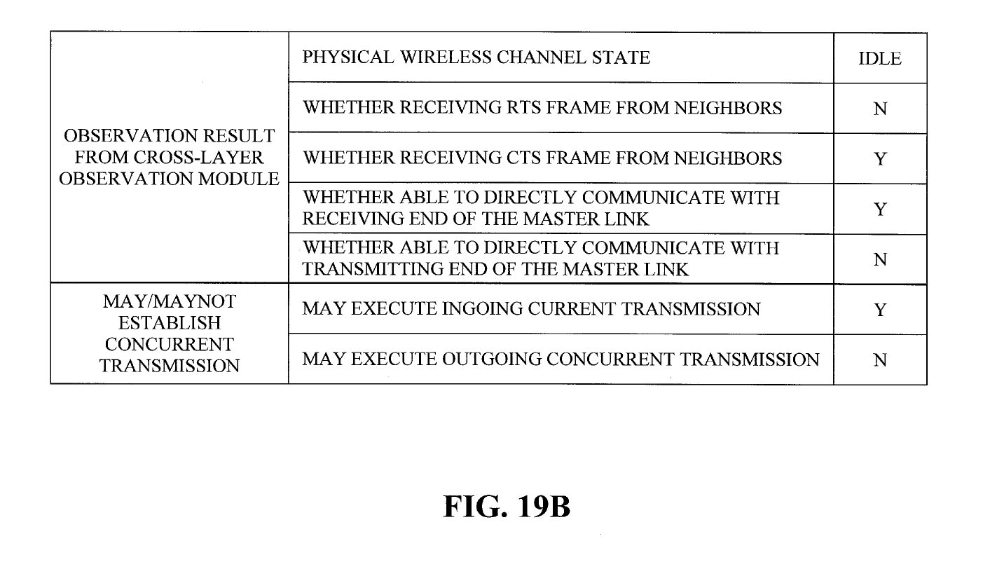

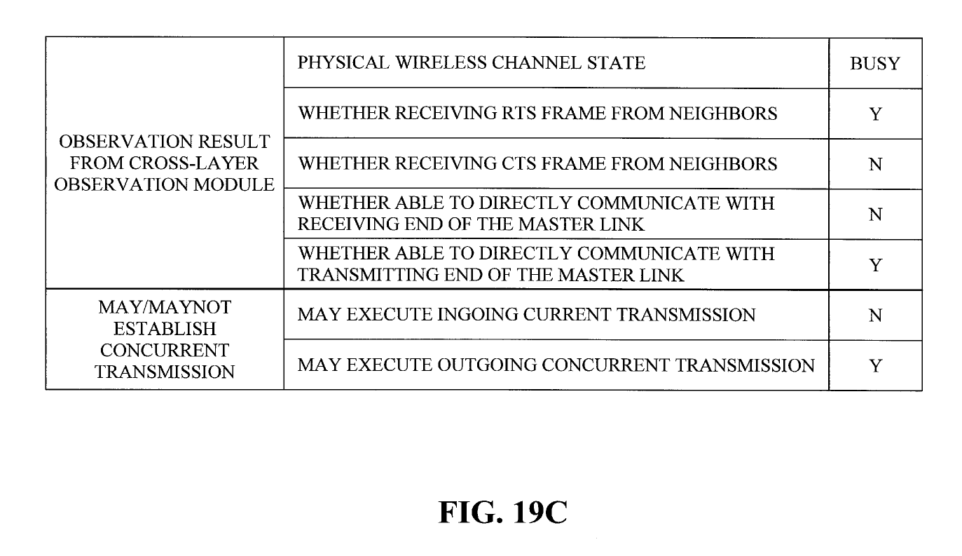

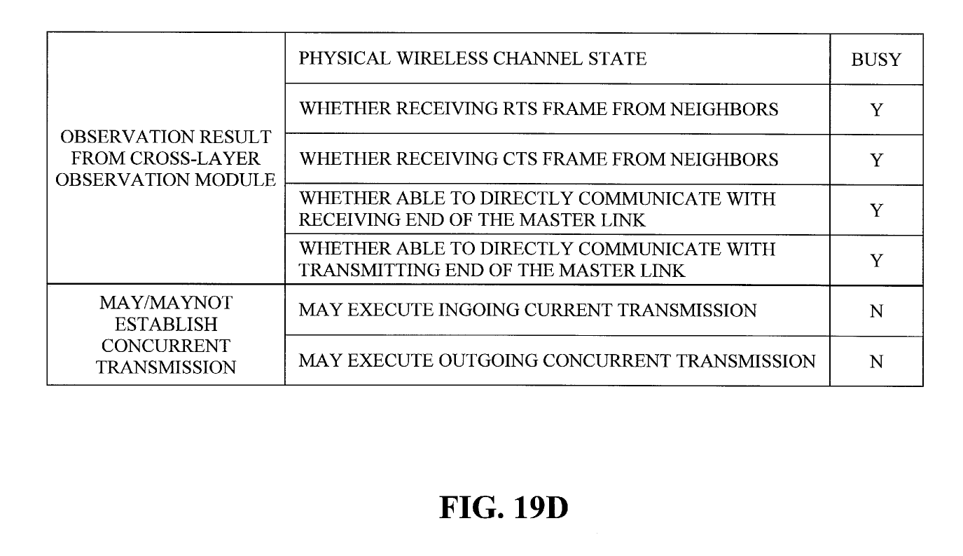

In summary, through the cross-layer observation module to observe physical and virtual carrier sensing, RTS/CTS frame and overhearing the RA field and TA field of RTS/CTS frame, each node determines whether a slave link may be established. According to the observed information, NACT MAC protocol integrates physical and virtual carrier sensing to determine whether concurrent transmission can be executed for each observed result. This also solves the hidden or exposed node problems. Take the network topology in FIG. 11 as an example. The decision to whether concurrent transmission is established may be obtained for different observation results. For example, FIG. 19A-FIG. 19D show the results, consistent with certain disclosed embodiments.

The exemplar of FIG. 19A shows that node D may use cross-layer observation module to observe the RTS frame from node E to determine whether concurrent transmission may be established. In other words, the correct result that neither ingoing nor outgoing concurrent transmission may be established is determined.

The exemplar of FIG. 19B considers the ingoing concurrent transmission and node A is establishing link to node B, described as follows. Referring to FIG. 19B, through the observation result from cross-layer observation module, node C knows that (1) physical wireless channel is idle, (2) because node C only receives CTS frame from node B, therefore, nod B is currently receiving, (3) through CTS frame, node C knows that the transmitting end and receiving end of the master link are node A and node B, respectively. Then, by inquiring the result of the neighbor discover procedure, node C knows that the transmitting end (node A) of the master link fails to directly communicate with node C, and knows from the result of neighbor discover procedure that node A and node B both support TACT MAC. Hence, node C knows that node C may become a receiving end of a slave link. In other words, it is determined that ingoing concurrent transmission may be established.

The exemplar of FIG. 19C considers the outgoing concurrent transmission and node B is establishing a link to node A, described as follows. Referring to FIG. 19C, through the observation result from cross-layer observation module, node C determines that node C may become a transmitting end of a slave link. In other words, through the observation result from cross-layer observation module, node C knows that (1) physical wireless channel is busy, (2) because node C only receives RTS frame from node B, therefore, nod B is currently transmitting, (3) through RTS frame, node C knows that the transmitting end and receiving end of the master link are node B and node A, respectively. Then, by inquiring the result of the neighbor discover procedure, node C knows that the receiving end (node A) of the master link fails to directly communicate with node C, and knows from the result of neighbor discover procedure that node B and node A both support TACT MAC. Hence, node C knows that node C may become a transmitting end of a slave link. In other words, it is determined that outgoing concurrent transmission may be established.

In addition, the corresponding table of the other cases, such as the exemplar in FIG. 19D, may also be established following the same method. NACT MAC protocol of the disclosed may also use a corresponding map to determine whether concurrent transmission may be established for each cross-layer observation result.

Although the present invention has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An apparatus for neighbor-aware concurrent transmission (NACT) media access control (MAC) protocol, for identifying whether a plurality of communication links being able to be established concurrently in a wireless network, said apparatus comprising:
a neighbor discover module being operative for each node of said wireless network to obtain topology information of said node's neighbors within multi-hops; and
a cross-layer observation module that integrates physical and virtual carrier sensing, observes address field of a control frame of a MAC layer in said wireless network, and compares said address field information of said control frame against said topology information obtained by said neighbor discover module to determine whether said plurality of links being allowed to be established for concurrent transmission.

2. The apparatus as claimed in claim 1, wherein said cross-layer observation module determines which node in said wireless network is transmitting end or receiving end of a master link of said wireless network, and whether said node supports concurrent transmission by said information in said address field of said control frame.

3. The apparatus as claimed in claim 2, wherein said concurrent transmission established by each said node of said wireless network is either an ingoing concurrent transmission or an outgoing concurrent transmission.

4. The apparatus as claimed in claim 1, wherein said cross-layer observation module achieves virtual wireless channel sensing by employing said control frame.

5. The apparatus as claimed in claim 4, wherein said cross-layer observation module integrates said physical and virtual carrier sensing through physical wireless channel sensing and virtual wireless channel sensing.

6. The apparatus as claimed in claim 1, wherein establishing concurrent transmission of said plurality of communication links follows a mutually interference-free transmission protocol.

7. The apparatus as claimed in claim 1, said apparatus is a wireless network transmitter and receiver.

8. The apparatus as claimed in claim 1, said apparatus is a wireless network card.

9. The apparatus as claimed in claim 1, wherein said cross-layer observation module executes physical wireless channel sensing, uses said control frame to achieve virtual wireless channel sensing, and observes address field information of said control frame of a node of said wireless network to determine which node in said wireless network is a transmitting end or receiving end of a master link of said wireless network, and whether said node being a transmitting end or receiving end of said master link is allowed to directly communicate with said node being observed address field information of said control frame.

10. The apparatus as claimed in claim 9, said apparatus constructs a corresponding map to determine whether concurrent transmission is allowed to be established for each observation result by said cross-layer observation module.

11. A method for neighbor-aware concurrent transmission (NACT) media access control (MAC) protocol, for identifying a plurality of communication links being able to be established concurrently in a wireless network, said method comprising:
executing a neighbor discover procedure for each node of said wireless network to obtain topology information of said node's neighbors within multi-hops;
through a cross-layer observation module, integrating physical and virtual carrier sensing, observing address field of a control frame of a MAC layer in said wireless network; and
comparing said address field information of said control frame against said topology information obtained by said neighbor discover module to determine whether said plurality of links are allowed to be established for concurrent transmission.

12. The method as claimed in claim 11, said method further includes:
determining which node in said wireless network being transmitting end or receiving end of a master link of said wireless network and whether said node has a capability of supporting concurrent transmission, by employing the information of said address field of said control frame.

13. The method as claimed in claim 12, wherein said concurrent transmission established by each said node of said wireless network is either an ingoing concurrent transmission or an outgoing concurrent transmission.

14. The method as claimed in claim 11, said method further includes physical wireless channel sensing, and employing said control frame to achieve virtual wireless channel sensing.

15. The method as claimed in claim 13, wherein said ingoing concurrent transmission at least includes:
checking whether transmitting end or receiving end of a master link supporting concurrent transmission;
if so, said master link waiting for a delay duration before transmitting data frame;
through information of said address field of said cross-layer observation module, each node of said wireless network identifying whether said node itself may become a receiving end of a slave link; and
synchronizing one or more reply frames between said master link and said slave link.

16. The method as claimed in claim 13, wherein said outgoing concurrent transmission at least includes:
checking whether transmitting end or receiving end of a master link supporting concurrent transmission;
if so, through information of said address field of said cross-layer observation module, each node of said wireless network identifying whether said node itself may become a transmitting end of a slave link;
if so, receiving end of said salve link ignoring Clear-To-Send frame; and
synchronizing one or more reply frames between said master link and said slave link.

17. The method as claimed in claim 12, wherein said identifying transmitting end or receiving end of said master link further includes:
observing information in a frame type field of said control frame, and determining type of frame received by a node;
when said received frame being a Clear-To-Send (CTS) frame, setting a variable to indicate required waiting duration for said node when concurrent transmission unable to be established, reading receiver address (RA) field of said CTS frame and setting receiving end of said master link to said RA; and
when said received frame type being a Request-To-Send (RTS) frame, setting a variable to indicate required waiting duration for said node when concurrent transmission unable to be established, reading RA and transmitter address (TA) fields of said RTS frame and setting transmitting end of said master link to said TA and receiving end of said master link to said RA.

18. The method as claimed in claim 15, said method employs a double channel check (DCC) to avoid a false blocking node problem.

19. The method as claimed in claim 12, wherein each node in said wireless network observe physical carrier sensing, Request-To-Send (RTS)/Clear-To-Send (CTS) frame, and address field of overheard RTS/CTS frame to determine whether a slave link may be established through said cross-layer observation module.
